(19) United States
(12) Patent Application Publication
(10) Pub. No.: US 2016/0009356 A1
(43) Pub. Date: Jan. 14, 2016

(54) AIRCRAFT FUSELAGE PROVIDED WITH INTERIOR FIT-OUT EQUIPMENT

(71) Applicant: Airbus Corporate Jet Centre, Blagnac (FR)

(72) Inventors: Sylvain MARIAT, Leguevin (FR); Jean-Cyrille DESTIEU, Merville (FR); Béranger CHANTAL, Bretx (FR); Jean-Luc LEGROS, Toulouse (FR); Nicolas FERRERE, La Villedieu Du Temple (FR); Pascal TAFFARELLO, Bessieres (FR)

(21) Appl. No.: 14/750,865

(22) Filed: Jun. 25, 2015

(30) Foreign Application Priority Data
Jul. 10, 2014 (FR) 14 56642

(51) Int. Cl. B64C 1/06

(52) U.S. Cl. CPC B64C 1/066

(57) ABSTRACT

An aircraft fuselage provided with interior fit-out equipment, including a structure and decorative panels fixed to the structure one after the other at the level of at least one fixing point by a detachable link and delimiting a cabin. The fuselage further includes interior fit-out equipment disposed between two neighboring decorative panels which includes a base fixed to the fuselage, a flap mounted movably in respect of the base between a closed position in which the fixing points are hidden and inaccessible and an open position in which the fixing points are visible and accessible, and a lock that can be moved between a locked position in which the flap is kept in the closed position and an unlocked position in which the flap is free to move from the closed position into the open position and vice versa. Access to the fixing points is easy by moving the flap.

### CROSS-REFERENCE TO RELATED APPLICATION

This application claims the benefit of and priority to French patent application No. 14 56642 filed on Jul. 10, 2014, the entire disclosure of which is incorporated by reference herein.

### BACKGROUND

The present disclosure relates to an aircraft fuselage provided with interior fit-out equipment and also an aircraft having a fuselage of this kind.

An aircraft traditionally comprises a fuselage made up of a structure comprising an assembly of formers and panels which are fixed onto the formers and create the outer skin of the aircraft.

Technical elements intended, for example, for the ventilation network, the oxygen network and the electrical network are arranged inside the fuselage.

In order to prevent these elements from being visible from inside the cabin, the fuselage is provided with decorative panels fixed in a detachable fashion to the structure, in particular to the formers, at the level of the fixing points.

For aesthetic reasons, the fixing points have to be hidden, but for maintenance reasons, the fixing points have to be easily accessible.

At present, there is no device that fully meets both requirements.

### SUMMARY

An object of the present disclosure is that of proposing an aircraft fuselage which does not display the disadvantages of the prior art and which, in particular, is provided with interior fit-out equipment that allows the fixing points of the decorative panels to be hidden, while at the same time allowing quick and easy access to these fixing points when required.

To this end, an aircraft fuselage is proposed comprising:
a structure; and
decorative panels delimiting a cabin and fixed to the structure one after the other at the level of at least one fixing point by a detachable link;

the fuselage comprising interior fit-out equipment disposed between two neighboring decorative panels which comprises:
a base fixed to the fuselage;
a flap mounted movably in respect of the base between a closed position in which the fixing points are hidden and inaccessible and an open position in which the fixing points are visible and accessible; and
a lock that can be moved between a locked position in which the flap is kept in the closed position and an unlocked position in which the flap is free to move from the closed position into the open position and vice versa.

Hence, the fixing points are hidden, but by unlocking the lock and moving the flap, they quickly become accessible.

The fuselage advantageously comprises a passage between a decorative panel and the flap and the lock is disposed between the flap and the decorative panel and is accessible through the passage.

The flap advantageously exhibits a recess with an opening and a wall extending partly across the opening.

The fuselage advantageously comprises a light source housed in the recess and a transparent plate closing the opening.

The base advantageously comprises at least one groove and the flap exhibits, for the groove or for each groove, a lug formed according to the shape of the groove.

The interior fit-out equipment advantageously comprises a stop system provided to take up, alternatively, a stop position in which the lug is in the stop position against the stop system to prevent movement of the lug and a retracted position in which the lug is released from the stop system and is able to move beyond or within the position corresponding to the stop position.

A surface of the lug advantageously slides over a surface of the groove and the surface of the lug exhibits waves.

The interior fit-out equipment advantageously comprises a flexible link connecting the flap to the base or to a decorative panel.

The lock advantageously comprises:
a finger mounted on the flap and rotationally movable about its axis, the finger being cylindrical in form about its axis but exhibiting two parallel flat surfaces on both sides of the axis of the finger;
two jaws mounted in a fixed manner on the fuselage, each jaw being provided in order to come to bear against a flat surface when the flap is in the closed position; and
a triggering system provided in order to make the finger make a quarter turn about its axis.

The fuselage advantageously comprises at least one duct system provided to supply the cabin with air and disposed on the side opposite the cabin in relation to the decorative panels, the fuselage comprises a passage towards the cabin between the flap and one of the decorative panels and the flap comprises an air guide provided to guide the air coming from the duct system or from each duct system towards the passage.

The air guide is advantageously made up of an upper wall extending along the flap, a lower wall substantially parallel to the upper wall and a diffusion wall disposed between a longitudinal side of the upper wall and a longitudinal side of the lower wall, the other two longitudinal sides of the upper wall and the lower wall delimit an opening provided to face the outlet of the duct system or of each duct system and the diffusion wall has holes drilled in it.

The lower wall is advantageously realized in a material with strong sound absorption.

The disclosure herein likewise proposes an aircraft comprising a fuselage according to one of the preceding variants.

### BRIEF DESCRIPTION OF THE DRAWINGS

The characteristics of the aforementioned disclosure herein, as well as others, will become clearer on reading the following description of an exemplary embodiment, the description relating to the attached drawings, in which:

FIG. 1 is a schematic representation of an aircraft according to the disclosure herein;

FIG. 2 shows a section of the aircraft fuselage provided with interior fit-out equipment according to the disclosure herein through a plane perpendicular to the longitudinal axis of the aircraft;

FIGS. 3 through 6 show an enlargement of the interior fit-out equipment according to a first embodiment of the disclosure herein and in different positions of use;

FIG. 7 shows an enlargement of the interior fit-out equipment according to a second embodiment of the disclosure herein;

FIG. 8 shows an example of a lock implemented in the disclosure herein; and

FIG. 9 shows a perspective view of a detail of the interior fit-out equipment.

### DETAILED DESCRIPTION

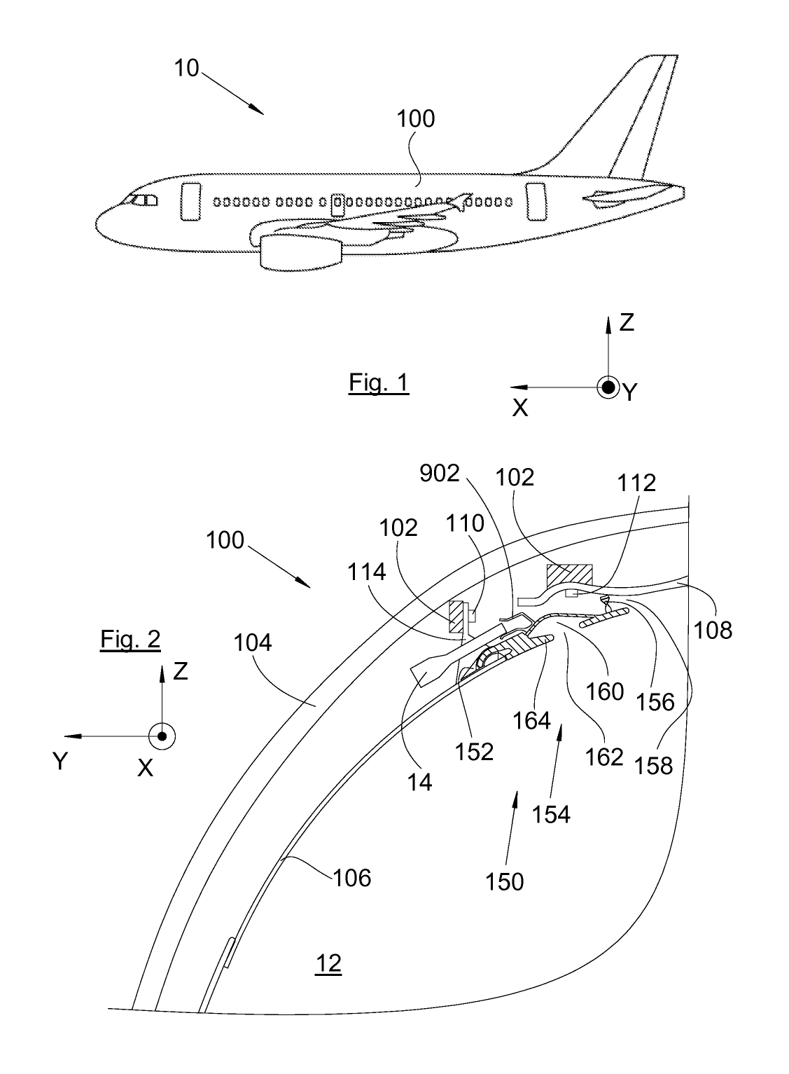

FIG. 1 shows an aircraft 10 comprising a fuselage 100 exhibiting a longitudinal axis referred to as X, an axis extending horizontally and laterally and referred to as Y and an axis extending vertically and referred to as Z.

FIG. 2 shows a section through the fuselage 100 which comprises a structure 102 principally made up of longitudinal formers, external panels 104 fixed onto the structure 102 and forming the external skin of the aircraft 10.

In order to hide the structure 102, the external panels 104 and the different technical elements being fixed to the structure 102, the fuselage 100 likewise comprises decorative panels 106 and 108 which delimit the cabin 12 of the aircraft 10.

The decorative panels are of two types in this case, decorative side panels 106 and decorative ceiling panels 108. The decorative panels 106 and 108 are fixed one after the other along the longitudinal axis X.

Each decorative panel 106, 108 is fixed to the structure 102 at the level of at least one fixing point 110, 112 by a detachable link that can be of any type and which is symbolized here by a clamping screw.

According to the embodiment of the disclosure herein presented in FIG. 2, it is an extension 114 of the decorative side panel 106 that is fixed to the structure 102 and it is the decorative ceiling panel 108 that is fixed directly to the structure 102.

The fuselage 100 likewise comprises interior fit-out equipment 150 which is disposed between two neighboring decorative panels 106 and 108. The interior fit-out equipment 150 comprises a base 152 fixed to the fuselage 100 and a flap 154 mounted movably in respect of the base 152 between a closed position in which the fixing points 110 and 112 of the decorative panels 106 and 108 are hidden and inaccessible and an open position in which the fixing points 110 and 112 of the decorative panels 106 and 108 are visible and accessible.

The interior fit-out equipment 150 likewise comprises a lock 156 which can be moved between a locked position in which the flap 154 is held in the closed position and an unlocked position in which the flap 154 is free to move from the closed position to the open position and vice versa.

Hence, when the flap 154 is locked in the closed position, the fixing points 110, 112 of the decorative panels 106 and 108 are hidden, and when the flap 154 is in the open position, the fixing points 110 and 112 of the decorative panels 106 and 108 are visible and can be dismantled for maintenance reasons, for example.

Access to the fixing points 110 and 112 is likewise easy due to the fact that there is no need to use a specific tool and a simple action on the lock 156 allows the flap 154 to be released.

In order to hide the space between two neighboring decorative panels 106 and 108, the flap 154 extends right along the neighboring zone between these two decorative panels 106 and 108. In the embodiment of the disclosure herein presented here, the flap 154 extends in the direction of the longitudinal axis X between a decorative side panel 106 and a decorative ceiling panel 108.

So that the lock 156 remains hidden, it is disposed between the flap 154 and the structure 102. In the embodiment of the disclosure herein presented here, the lock 156 is disposed between the flap 154 and a decorative panel 106, 108, in this case the decorative ceiling panel 108. The fuselage 100 then exhibits a passage 158 between the flap 154 and the decorative panel 106, 108, through which the lock 154 is accessible and can be locked or unlocked from the inside of the cabin 12.

The flap 154 exhibits a recess 160, the opening 162 whereof is oriented towards the cabin 12 and a wall 164 extending partly across the opening 162. This wall 164 can then act as a handrail for a person moving about in the cabin 12. The recess 160, the opening 162 and the wall 164 preferably extend right along the flap 154.

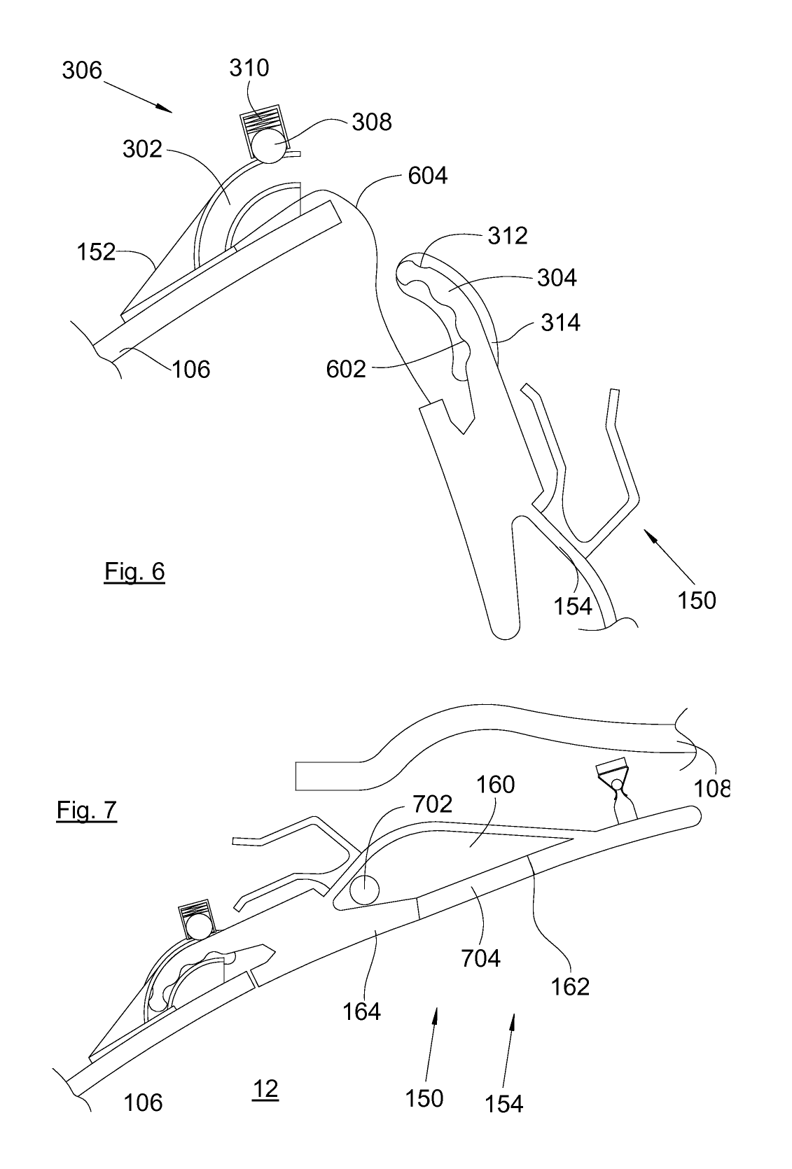

FIG. 7 shows another embodiment of the disclosure herein in which the recess 160 acts as a housing for a light source 702, for example an array of light-emitting diodes (LED), and in which the opening 162 is closed by a transparent plate 704 thereby allowing light to diffuse into the cabin 12.

In the embodiment of the disclosure herein presented in FIGS. 2 through 7, the base 152 is fixed against the decorative side panel 106, but it could be fixed to any other element of the fuselage 100 such as, for example, an element of the structure 102.

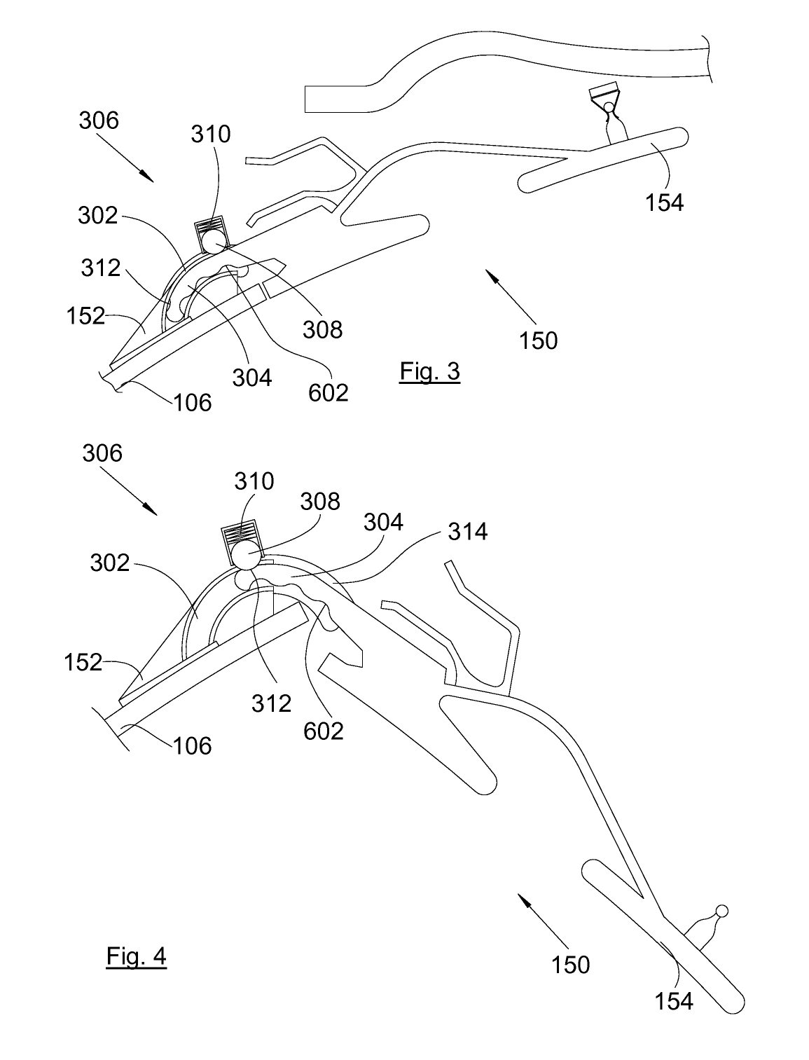

FIGS. 3 through 6 show a particular kinematic movement between the flap 154 and the base 152. The particular kinematic movement involves a rotation of the flap 154 in relation to the base 152. This rotation allows the space to be disengaged with regard to the fixing points 110 and 112.

The base 152 contains at least one groove 302 and the flap 154 exhibits a lug 304 for the groove or for each groove 302, the shape of which lug is formed according to the shape of the groove 302, in order to allow the lug 304 to slide in the groove 302.

In the embodiment of the disclosure herein shown here, each groove 302 and each lug 304 exhibits a circular arc form, but other forms can be envisaged depending on the space available around the interior fit-out equipment 150. It is possible to envisage straight grooves and lugs, for example.

Due to the length of the interior fit-out equipment 150 according to the longitudinal axis X and in order to ensure a fluid movement of the flap 154, it is preferable for the base 152 to have at least two grooves 302 distributed over the length.

The groove 302 in this case is a crossing groove and each lug 304 is bounded on either side by the flanks 314 acting as a guiding surface by bearing against the walls delimiting the groove 302.

FIG. 3 shows the flap 154 which is in the closed position.

FIG. 4 shows the flap 154 in the open position in which the lug 304 is always in the groove 302.

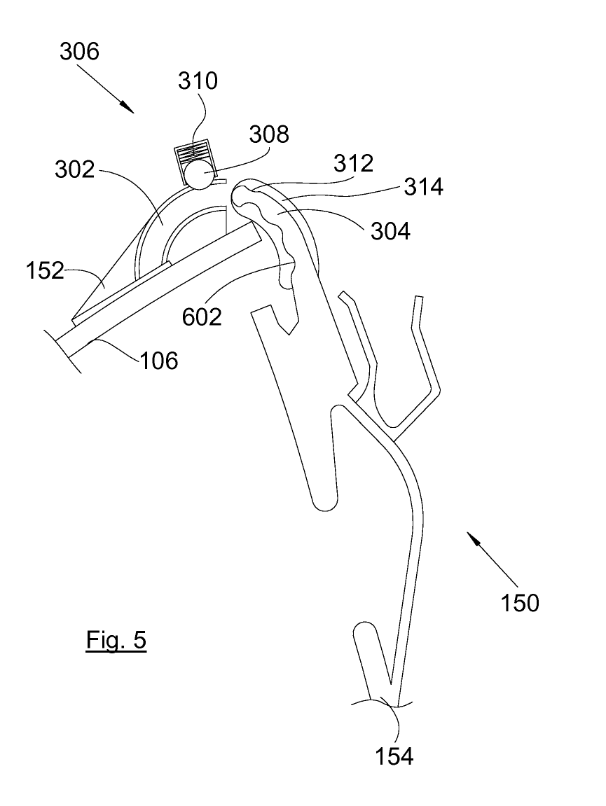

FIG. 5 shows the flap 154 in the open position when the lug 304 is released from the groove 302.

FIG. 6 shows the flap 154 in the open position when the lug 304 is fully released from the groove 302.

FIG. 4 corresponds to the maximum opening of the flap 154 before it is released from the base 152. In order to realize this position, the interior fit-out equipment 150 comprises a stop system 306 which is provided to take up, alternatively, a stop position (FIG. 4) in which the flap 154, and more particularly in this case the lug 304, reaches the stop position against the stop system 306, in order to prevent the movement of the lug 304 or a retracted position in which the lug 304 is released from the stop system 306 and is able to move beyond or within the position corresponding to the stop position. The stop position corresponds to an optimum opening for allowing easy access to the fixing points 110 and 112. The angular opening in the stop position is at least 62°, for example.

The stop system 306 is realized in this case by a ball 308 put under pressure by a spring 310 against a wall of the lug 304 which comprises a cavity 312 intended to receive the ball 308 in the stop position. Hence, when the ball 308 is not opposite the cavity 312, it rolls over the lug 304 which is able to move freely and when the ball 308 is located opposite the cavity 312, it sinks into it, thereby blocking the movement of the lug 304 and therefore of the flap 154.

A simple action on the flap 154, involving pushing or pulling, allows the ball 308 to disappear, which releases the lug 304 and allows the flap 154 to move beyond or within the position corresponding to the stop position.

During movement of the lug 304 in the groove 302, a surface of the lug 304 slides over a surface of the groove 302.

In order to limit the friction between these two surfaces, one of them, the surface of the lug 304 in this case, exhibits waves 602, which limits the contact surface between the two surfaces.

In order to prevent the flap 154 from dropping and being lost when it is fully released from the groove 302, the interior fit-out equipment 150 comprises a flexible link 604 which connects the flap 154 to the base 152 or to a decorative panel, in this case the decorative side panel 106.

This flexible link 604 can be detached to allow the flap 154 to be completely removed.

The flap 154 is returned to its position in the opposite direction.

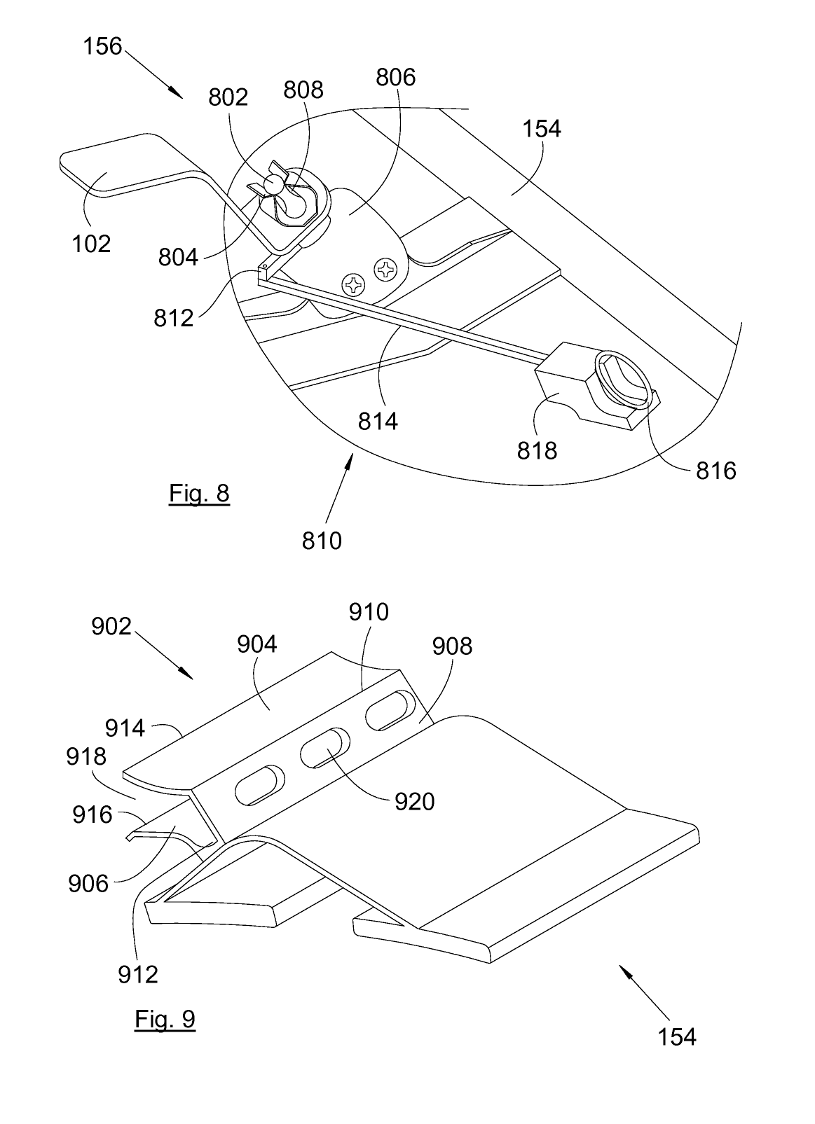

FIG. 8 shows a sample lock 156 comprising:
a finger 802 mounted on the flap 154 and rotationally movable about its axis; and
two jaws 804 mounted in a fixed manner on the fuselage 100 and, more particularly, on the structure 102.

The finger 802 is mounted in this case on the flap 154 by a shoe 806 which is fixed on the flap 154 and on which the finger 802 is rotationally movable.

The finger 802 is of cylindrical form about its axis but exhibits two parallel flat surfaces 808 on both sides of the axis of the finger 802.

When the flap 154 is in the closed position, the finger 802 is received between the two jaws 804 and each jaw 804 comes to bear against a flat surface 808.

In order to unlock the lock 156, the finger 802 is moved rotationally by a quarter turn, which moves the flat surfaces 808 and tends to spread the jaws 804 apart so that they are then able to let the finger 802 pass through. The finger 802 can then be removed from the jaws 804 (from the bottom in this case), allowing the flap 154 to move into the open position.

In order to pivot the finger 802 by a quarter turn, the lock 156 likewise comprises a triggering system 810.

The triggering system 810 comprises a lever 812 integral with the finger 802, a rod 814 fixed to the lever 812 by a pivoting link and an actuator 816 integral with the rod 814 and which takes the shape of a ring in this case.

When the lock 156 has to be unlocked, an operative grabs the actuator 816 and pulls it down, which action rotates the lever 812 and therefore the finger 802.

The guiding of the rod 814 in this case is performed by a guide 818 integral with the flap 154.

The return of the finger 802 into its original position may be carried out by a reverse movement of the actuator 816 and the rod 814 or by the positioning of a return spring.

FIG. 9 shows a detail of the flap 154 which includes an air guide 902 fixed to the flap 154 from the side of the flap 154 turned opposite the cabin 12, in other words turned towards the structure 102.

The fuselage 100 comprises at least one duct system 14 (FIG. 2) through the outlet whereof passes air intended for the cabin 12. The duct system or each duct system 14 is disposed on the side opposite the cabin 12 in relation to the decorative panels 106, 108. The outlet of the duct system or of each duct system 14 is oriented towards the passage 158.

The air guide 902 is provided to guide the air coming from the duct system or each duct system 14 towards the passage 158. The air guided by the air guide 902 thereby passes between the decorative panel, in this case the decorative ceiling panel 108, and the flap 154, leaving through the passage 158 and supplying the cabin 12.

The air guide 902 in this case is made up of an upper wall 904 extending along the flap 154 parallel to the longitudinal direction X, a lower wall 906 substantially parallel to the upper wall 904 and a diffusion wall 908 disposed between a longitudinal side 910 of the upper wall 904 and a longitudinal side 912 of the lower wall 906. The other two longitudinal sides 914 and 916 of the upper wall 904 and the lower wall 906, respectively, delimit an opening 918. The air guide 902 thereby takes the shape of a U-shaped profile oriented longitudinally parallel to the longitudinal direction X.

The diffusion wall 908 has holes 920 drilled in it.

When the flap 154 is in the closed position, the opening 918 is intended to face the outlet of the duct system or of each duct system 14 (FIG. 2) and the air coming from the duct system or each duct system 14 passes between the lower wall 906 and the upper wall 904, leaving through the diffusion wall 908 and reaching the passage 158.

In order to limit the airborne noise generated at the outlet of the duct system or of each duct system 14, the lower wall 906 is realized in a material with strong sound absorption, such as a polymer foam, for example.

While at least one exemplary embodiment of the present invention(s) has been shown and described, it should be understood that modifications, substitutions and alternatives may be apparent to one of ordinary skill in the art and can be made without departing from the scope of the disclosure described herein. This application is intended to cover any adaptations or variations of the specific embodiments discussed herein. In addition, in this disclosure, the terms “comprise” or “comprising” do not exclude other elements or steps, and the terms “a” or “one” do not exclude a plural number. Furthermore, characteristics or steps which have been described with reference to one of the above exemplary embodiments may also be used in combination with other characteristics or steps of other exemplary embodiments described above.

1. An aircraft fuselage comprising:
a structure; and
decorative panels delimiting a cabin and fixed to the structure one after the other at the level of at least one fixing point by a detachable link;
the fuselage further comprising interior fit-out equipment disposed between two neighboring decorative panels which comprises:
a base fixed to the fuselage,
a flap mounted movably in respect of the base between a closed position in which the fixing points are hidden and inaccessible and an open position in which the fixing points are visible and accessible; and
a lock that is movable between a locked position in which the flap is kept in the closed position and an unlocked position in which the flap is free to move from the closed position into the open position and vice versa.

2. The fuselage as claimed in claim 1, comprising a passage between a decorative panel and the flap and the lock is disposed between the flap and the decorative panel and is accessible through the passage.

3. The fuselage as claimed in claim 1, wherein the flap comprises a recess with an opening and a wall extending partly across the opening.

4. The fuselage as claimed in claim 3, comprising a light source housed in the recess and a transparent plate closing the opening.

5. The fuselage as claimed in claim 1, wherein the base comprises at least one groove and the flap exhibits, for the groove or for each groove, a lug formed according to the shape of the groove.

6. The fuselage as claimed in claim 5, wherein the interior fit-out equipment advantageously comprises a stop system provided to take up, alternatively, a stop position in which the lug is in the stop position against the stop system to prevent movement of the lug and a retracted position in which the lug is released from the stop system and is able to move beyond or within the position corresponding to the stop position.

7. The fuselage as claimed in claim 5, wherein a surface of the lug advantageously slides over a surface of the groove and the surface of the lug exhibits waves.

8. The fuselage as claimed in claim 1, wherein the interior fit-out equipment comprises a flexible link connecting the flap to the base or to a decorative panel.

9. The fuselage as claimed in claim 1, wherein the lock comprises:
a finger mounted on the flap and rotationally movable about its axis, the finger being cylindrical in form about its axis but exhibiting two parallel flat surfaces on both sides of the axis of the finger;
two jaws mounted in a fixed manner on the fuselage, each jaw being provided in order to come to bear against a flat surface when the flap is in the closed position; and
a triggering system provided in order to make the finger make a quarter turn about its axis.

10. The fuselage as claimed in claim 1, comprising at least one duct system provided to supply the cabin with air and disposed on the side opposite the cabin in relation to the decorative panels, a passage towards the cabin between the flap and one of the decorative panels and the flap comprising an air guide provided to guide air coming from the duct system or from each duct system towards the passage.

11. The fuselage as claimed in claim 10, wherein the air guide comprises an upper wall extending along the flap, a lower wall substantially parallel to the upper wall and a diffusion wall disposed between a longitudinal side of the upper wall and a longitudinal side of the lower wall, the other two longitudinal sides of the upper wall and the lower wall delimit an opening provided to face the outlet of the duct system or of each duct system and the diffusion wall has holes drilled in it.

12. The fuselage as claimed in claim 11, wherein the lower wall comprises a material with strong sound absorption.

13. An aircraft comprising a fuselage as claimed in claim 1.
